(19) United States
(12) Patent Application Publication
(10) Pub. No.: US 2006/0077421 A1
(43) Pub. Date: Apr. 13, 2006

(54) System and method for driverless printers

(75) Inventors: Guy Eden, Tustin, CA (US); Lena Sojian, Fountain Valley, CA (US)

Correspondence Address: Gerald W. Maliszewski, P.O. Box 270829, San Diego, CA, 92198-2829, US

(73) Assignee: Sharp Laboratories of America, Inc.

(21) Appl. No.: 10/961,016

(22) Filed: Oct. 8, 2004

(51) Int. Cl. G06F 3/12

(52) U.S. Cl. 358/1.15

(57) ABSTRACT

A system and method are provided for processing digital documents using a print application manager. The method comprises: receiving a digital document in a raw file format from a network client at an MFP; determining the file format; recognizing a print application corresponding to the determined file format; accessing a registry of network-connected service providers cross-referenced to print applications; sending the digital document to a service provider with the recognized print application; receiving a print application-rendered digital document from the service provider; and processing the rendered digital document at the MFP. Typically, selecting a service provider from the registry includes: identifying a plurality of service providers cross-referenced to a particular print application; and selecting the service provider using a random or round-robin algorithm. In other aspects, the MFP determines print applications embedded with the network client; and adds the network client to the registry as a service provider.

### BACKGROUND OF THE INVENTION

1. Field of the Invention

This invention generally relates to digital document processing and, more particularly, to a system and method for rendering a digital document without the necessity of a network client-embedded print driver application.

2. Description of the Related Art

Conventionally, there are problems installing printer drivers on a terminal computer (network client) for a plurality of network (connected) printers. Any user who wants to connect to a set of printers, needs to first install a print driver for each printer, before they are able to print. Thus, a user may need to install a different set of print drivers on their terminal, for each different printer in the network. In addition to the burden of installing a multitude of drivers on each terminal, if a network environment includes terminals with different operating systems (OSs), then each printer may be forced to interact with many different variations of client-embedded drivers. Thus, a company manufacturing a new copier must write a driver for Microsoft Windows, a driver for MAC/Mainframe, a driver for Linux/Unix, and any other OS likely to be installed in a client terminal. When a driver is updated, then all client PCs need to install the new driver version.

The problem is compounded still further in that any one terminal is likely to have many different applications installed. Each application that renders a document to a network copier for printing, uses a different print driver. Different users have different applications installed on their machines. It's difficult and expensive for a single user to have all applications installed on their machine. Microsoft Office, Paint Shop Pro, Microsoft Visual Studio™, WillMaker, are all examples of relatively expensive applications that are either purchased, or licensed, that operate with an associated print driver.

For example, a user receives a schedule.mpp file from a team-mate, but unfortunately does not have Microsoft Project© installed on their network client terminal. So the user is unable to print the file. The user may ask for a portable document format (PDF) version of the document, as PDF is freeware, or install Microsoft Project, for which the user does not have a license. Either way, the user is inconvenienced.

It would be advantageous if an application and print driver for each file type, did not have to be installed on a network client in order to print any type of file.

### SUMMARY OF THE INVENTION

This invention describes a multifunctional peripheral (MFP) that can accept any file for printing (e.g., .DOC, .TXT, .PDF, .JPG, .BMP, .XLS, .HTML, or MPP). The MFP has a registry that maintains a list of available service providers. Each service provider has embedded one or more print drivers. If a network client has a document to print, but has no print driver for the document file type, the client sends the document to the MFP is the raw file format. The MFP goes through its list of driver providers, and makes a request to one of them, to render the document. If the provider supports the file type, it returns a rendered file that is the outcome of the parse. If the provider fails, then MFP may contact other providers for their rendering services.

This invention enables users to print documents without having the associated application installed on their terminal. Now, a user gets a schedule.mpp document file from their boss. This file should be opened by Microsoft project©. The user does not have Microsoft project© installed, but can still print the file. The network client determines that the raw file does not have an associated application installed on the current system. The client sends the raw file to the MFP. The MFP queries all the users logged onto the network until it can find a network client (service provider) with an application that supports the raw file extension is installed. The MFP sends the raw file to that provider, for rendering. The rendered result is sent back to the MFP for printing or processing.

Thus, each network client may both, request a rendering service, and act as a service provider for other network clients. Each network client/service provider implements a web service, accessed by the MFP. The network may consist of hundreds of users, and so the network becomes a service provider farm.

The printing process may include a validation step, to determine if a document type is supported by the current network client (to determine if the extension is supported by any installed application). If the document format is supported, it is rendered and sent to the MFP for printing. If it is not supported, the raw document is sent to the MFP. The MFP contacts other service providers (other network clients in the farm) until one can process the document. The larger the user inset, the larger the community, and thus the probability is larger that the sought driver can be found. This invention concerns sharing rendering capability. However, it's not a peer-to-peer environment because the MFP acts as an arbitrator between clients.

Accordingly, a method is provided for processing digital documents using a print application manager. As used herein, a print application a hybrid program that is a combination of an application and a print driver associated with the application. The method comprises: receiving a digital document in a raw file format from a network client at an MFP; determining the file format; recognizing a print application corresponding to the determined file format; accessing a registry of network-connected service providers cross-referenced to print applications; sending the digital document to a service provider with the recognized print application; receiving a print application-rendered digital document from the service provider; and processing the rendered digital document at the MFP.

The MFP may use a network scanning application to: discover connected service providers; discover the print applications embedded with each service provider; and build the registry using the service provider print application discoveries. Alternately, the MFP builds the registry in response to receiving detection queries and registry messages from service providers.

Typically, selecting a service provider from the registry includes: identifying a plurality of service providers cross-referenced to a particular print application; and selecting the service provider using a random or round-robin algorithm. In other aspects, the MFP determines print applications embedded with the network client; and adds the network client to the registry as a service provider.

Additional details of the above-described method and a digital document processing system for centrally managing digital document processing print applications are provided below.

### BRIEF DESCRIPTION OF THE DRAWINGS

FIG. 1 is a schematic block diagram illustrating a digital document processing system for centrally managing digital document processing print applications.

FIG. 2 is a diagram depicting an exemplary service provider registry.

FIG. 3 is a schematic block diagram illustrating another variation of the print application management system.

FIG. 4 is a diagram illustrating the process of rendering a document using the centrally managed printer application system.

FIG. 5 is another depiction of an exemplary service provider registry.

FIG. 6 is a flowchart illustrating a method for processing digital documents using a print application manager.

FIGS. 7A and 7B are flowcharts illustrating a variation in the method for processing digital documents using a print application manager.

### DETAILED DESCRIPTION

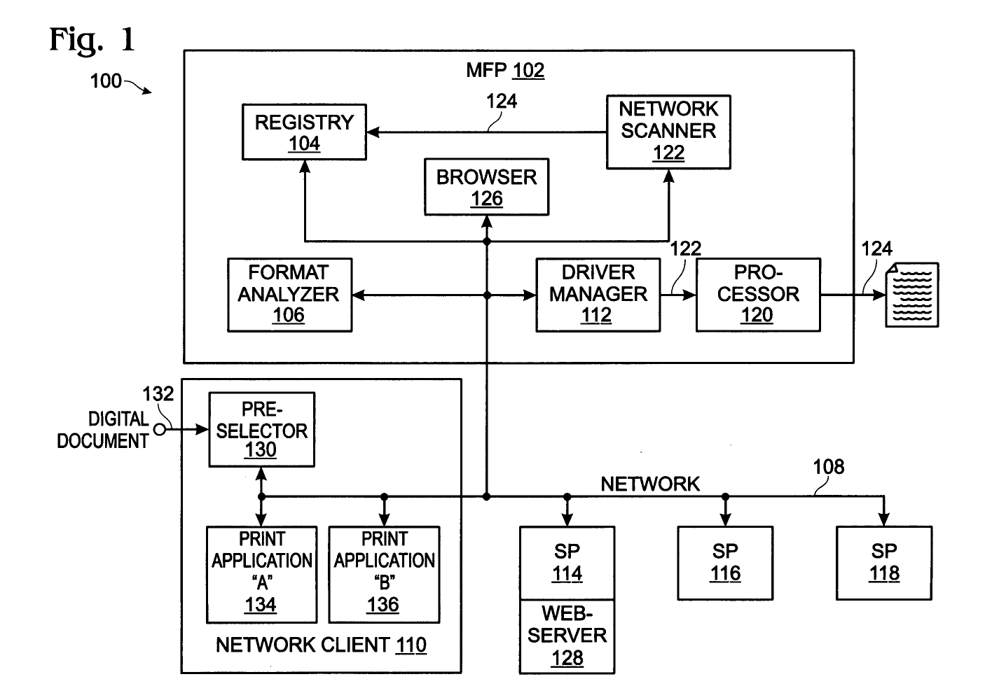

FIG. 1 is a schematic block diagram illustrating a digital document processing system for centrally managing digital document processing print applications. As shown, the system 100 is at least partially embedded in an MFP 102 and comprises a registry 104 of network-connected service providers cross-referenced to print applications. Although an MFP is shown, the system has applicability to a variety of other document processing devices such as copiers, printers, scanners, and fax machines, to name a few.

As noted earlier, a print application is defined herein to be a combination of an application and the print driver needed to render a document generated by the application for processes such as printing. Microsoft Word and Abode Acrobat are examples of applications. A printer driver is a program designed to allow other programs (applications) to work with a particular printer, without the application concerning itself with the specifics of the printer's hardware and internal language. By using printer drivers that handle the subtleties of each printer, programs can communicate properly with a variety of printers. For example, PostScript printer drivers create a file that is accepted by PostScript printers. HP printer drivers create PCL files, and so on. Drivers for Microsoft Windows-only printers rasterize the pages (RIP function) and send the actual bit patterns to the printer, which are applied to the drum by the laser or LED array. As an alternative to using the concept of a “print application”, the system 100 could also be explained in context of print drivers. However, “print application” is used to more accurately reflect the linkage between an application, print driver, and particular printer. Further, the system has applicability to other application processing drivers, such as a scanning driver.

A format analyzer 106 has an interface on line 108 to accept a digital document in a raw file format from a network client 110. Line 108 represents a network that can be an intranet, local area network (LAN), or Internet for example. The network client 110 can be a device such as a personal computer (PC), cellular telephone, or personal digital assistant (PDA). The invention is advantageous for use with clients that have limited memory for the storage of applications and print drivers. The invention is also advantageous for use with a portable client that must interface with printer models and makes that cannot be predetermined. For example, the user may be on travel with a portable network client, visiting a client. The invention is not limited to any particular class of network client devices.

The format analyzer 106 determines the file format and recognizes a print application corresponding to the determined file format. For example, the format analyzer may determine that a document has a .doc extension and thus recognize that a Microsoft Work print application is required. A driver manager 112 has an interface on line 108 for sending the digital document in the raw file format to a service provider 114 with the recognized print application. That is, the service provider 114 is known to have embedded the recognized print application. In response, the driver manager 112 receives a print application-rendered digital document from the service provider 114. The service provider can be a device such as a PC or network server. As discussed below, the service provider can be enabled as any type of network client device.

Typically, the system 100 is connected to a plurality of service providers (SPs). Also shown are service providers 116 and 118. Further, the MFP registry 104 may register the network client 110 as a service provider cross-referenced to print application embedded with the network client. That is, device 110 may act as a service provider to device 114 for example. A document processor 120 has an interface on line 122 from the driver manager, to accept the rendered digital document and to provide a processed document. For example, the document processor 120 may be a print engine that supplies a hardcopy of the document at interface 124.

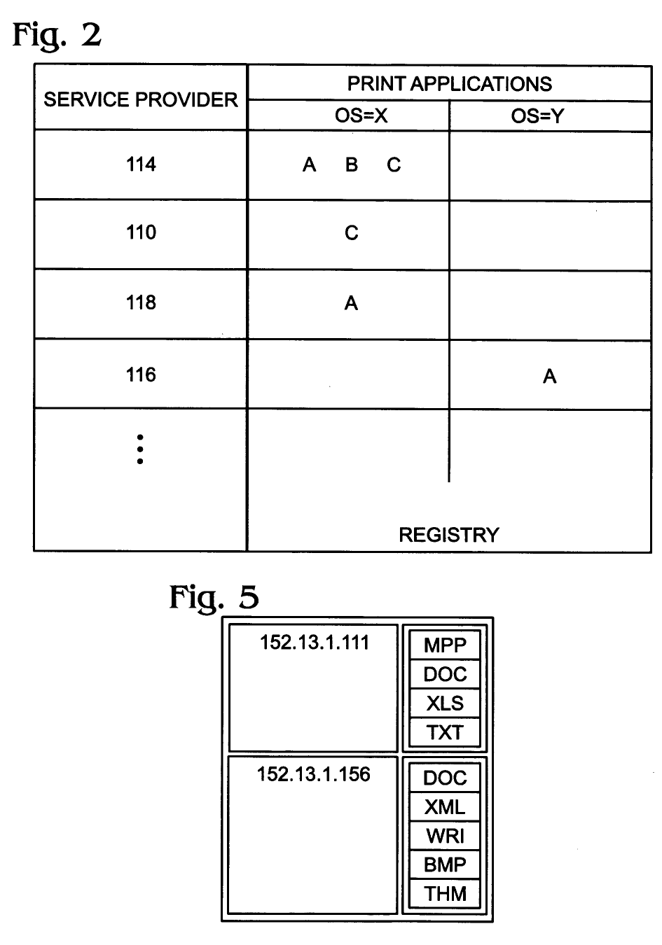

FIG. 2 is a diagram depicting an exemplary service provider registry. Service provider 114 is shown cross-referenced to a number of different print applications. Network client 110 is shown cross-referenced to print application “C”, in its capacity as a service provider.

Returning to FIG. 1, the format analyzer 106 may receive the digital document in a raw file format such as .doc, .txt, .pdf, .jpg, .smp, .xls, .html, or .mpp. However, the system 100 is not limited to any particular file formats. The driver manager 112 may receive print application-rendered digital document in a format such as printer control language (PCL), PostScript (PS), or raster image processing (RIP) data. The system is not limited to any particular type of print drive language (PDL) or rendered format.

The system's control over the service providers may vary. For example, the driver manager 112 may select a service provider from the registry 104, transmit a rendering request to the selected service provider, and send the digital document in response to receiving a rendering acknowledgement. Alternately, the rendering service may be demanded, as opposed to requested. As another example, the registry is rebuilt every time a service provider is sought (the MFP does not save the registry in persistent memory).

If the system 100 includes a network scanner 122 (network scanning application), then the network scanner has an interface on line 108 to discover connected service providers, and to discover the print applications embedded with each service provider. The network scanner sends the discovery results on line 124 so that the registry 104 can be built using the discoveries. For example, the system 100 may include a browser 126 with an interface for transmitting a rendering request to a selected service provider web server (i.e., web server 128 of service provider 114), in response to a request from the driver manager 112. Alternately, if discovery is not used, the registry 104 receives detection queries from service providers, and also receives registry messages from the service providers listing available embedded print applications. Then, the registry 104 is built using the registry messages.

In some aspects, the format analyzer 106 receives the digital document in a raw file format associated with a first operating system (OS). For example, there may be different first (“A”) print applications (and raw file formats) associated with both an “X” and “Y” OS. As shown in FIG. 2, the registry cross-references service providers to print applications, differentiated by OS. Thus, while service provider 114 has an “A” print application embedded for an “X” OS, service provider 116 has an “A” print application embedded for a “Y” OS. Returning to FIG. 1, thus, the driver manager 112 may receive a first OS differentiated print application-rendered digital document from the service provider.

Referencing FIGS. 1 and 2, the registry may cross-reference a plurality of service providers to a first (“A”) print application (using a common or different OS). As shown, print application “A” is embedded with server provide 114 and 118 (OS=X). The driver manager 112 may continually select the first service provider in the list. Alternately, the driver manager may select the first (“A”) print application service provider from the registry using a random selection or round-robin algorithm. In other aspects, the selection is based upon determining the service provider's load, available processing power, or network bandwidth constraints.

In a different aspect, the network client 110 includes a pre-selector 130 having an interface on line 132 for accepting a digital document in a raw file format. The pre-selector 130 determines if a print application is embedded in the network client 110 corresponding the file format. For example, the document raw file format uses a “,aaa” extension, requiring the first (“A”) print application. The pre-selector 130 determines if the first print application is embedded. The pre-selector has an interface on line 108 connected to the MFP 102 for sending the digital document in raw file format (.aaa) if a corresponding (“A”) print application is not embedded.

If the network client 110 has a (“A”) print application 134 embedded that corresponds to the (.aaa) file format. The pre-selector 130 sends the digital document in raw file format to the print application 134 for rendering. Print application 134 has an interface connected to the MFP on line 108 for sending a print application-rendered digital document (for processing).

The network client 110 may have an alternate (“B”) print application 136 embedded that does not correspond to the digital document raw file format (.aaa). The pre-selector 130 determines if the alternate print application 136 is embedded with the network client 110. If the corresponding (“A”) print application 134 is not embedded, the pre-selector sends the digital document to the alternate print application 136. The alternate print application 136 may convert the digital document from raw file format to PS format, and send the PS-rendered digital document through an interface on line 108 to the MFP 102 for additional rendering. In this particular case, the PS-rendered document can be considered to be in a raw, or semi-raw file format. For example, the MFP 102 may received the PS-rendered document and send the document to a service provider for conversion into a PCL format.

In another aspect, it is the pre-selector 130 that interacts with the MFP registry, registering the network client as a service provider cross-referenced to print application embedded with the network client. The interaction between pre-selector 130 and registry 104 may be a result of discovery by the MFP, or registry messages originated from the network client 110.

Many of the above-mentioned system elements can be enabled as software applications made up of a list of instructions that are stored in memory and executed using a microprocessor. Although only a single MFP is shown in the above-described system, it should be understood that the network clients (service providers) may be connected to a number of MFPs. The above-described system may be installed in some, or all of these MFPs. Likewise, network clients (service providers) may connect to different MFPs, so that the service providers managed by one MFP are different from those managed by a second MFP. Thus, a network client can access different services (print applications) using different MFPs. Further, the system can be enabled in systems of network devices that have a function other than printing or document processing.

### Functional Description

In one variation of the system, the driver services (the services installed on a server which implement driver parse capabilities) are discoverable. Discovery mechanisms are well known in the art for online network services. A service provider can be a web service that implements services consumable by network clients. The service provider implements a document rendering service, that is “consumed” by the printer (MFP). The MFP is able to discover connected service providers, and connect to them to consume their services.

In another variation, there is no discovery mechanism available, and so the MFP cannot enumerate the service providers. In this scenario the service providers have a copier-detection mechanism (as known in the art) that enables the service provider to detect MFPs that are connected to the sub network. The service provider registers itself with all detected copiers as a driver service provider. So all MFPs have a list of registered service providers, even if no discovery mechanism is available.

The service providers implement print drivers or print applications. A typical service provider will handle a raw file (e.g., .doc file) and render it to a PCL file. The service provider has a function to receive the raw file, for example by the HTTP protocol, as a DIME attachment, and a function to send the rendered file back to the MFP using a similar transfer protocol.

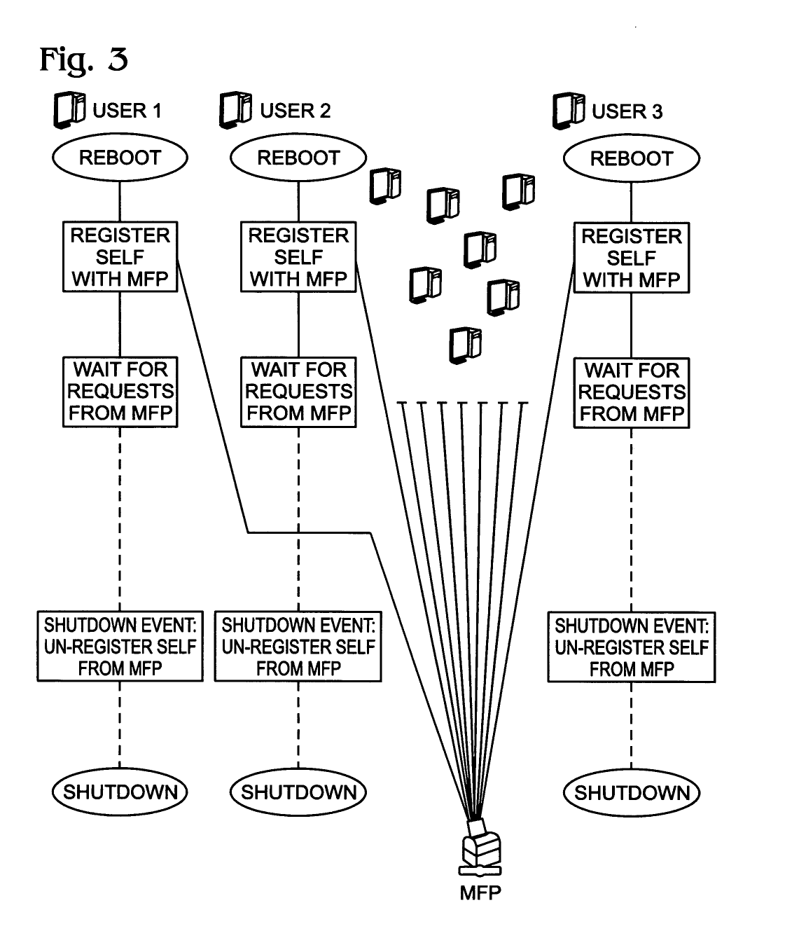

FIG. 3 is a schematic block diagram illustrating another variation of the print application management system. In this variation of the system, a service application, referred to herein as a pre-selector, can be installed on each network client. This application runs in the background. The pre-selector application implements a web service, and so the application can be referred to as a web application. The web service is “consumed” by the MFP.

As in the other variations, the MFP has a registry, where service providers register their services. Registering a service includes registering the destination (IP) of the service provider, and some extra data, regarding the capability of the service. The pre-selector application installed on each network client registers as a service provider at machine startup time with the MFP(s). This registry process is similar to the dynamic host configuration protocol (DHCP) environment, in which the host PC negotiates an IP address each time the PC reboots. Thus, each MFP's registry consists of all logged on users implementing the service. The pre-selector application un-registers itself as a service provider at system shut-down time.

Different network clients (service providers) may have different print applications installed on them, and the complete set of print applications installed on all the service providers define the set of documents which the MFP print application manager can support.

When the user issues a print command, the pre-selector application examines the client for a print application that is associated with the given document. If the document is a .mpp, then the pre-selector application looks for a print application embedded on the client that accepts .mpp files. If Microsoft schedule is installed on the client, then the pre-selector application sends the .mpp file to Microsoft Schedule© for rendering. That is, if the document has an associated application, then the associated application will be launched (e.g., Microsoft Schedule©)), the document rendered, and the print command issued.

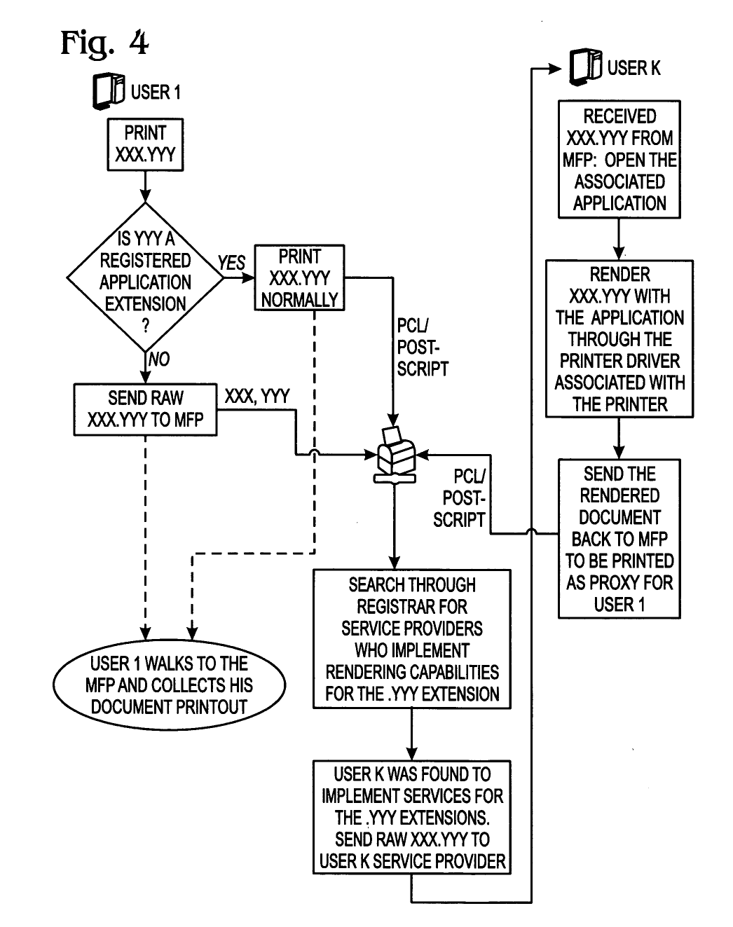

FIG. 4 is a diagram illustrating the process of rendering a document using the centrally managed printer application system. If the document type is not known to the client, then the pre-selector application sends the raw document to the MFP. The MFP receives the raw file format document. The MFP searches with its registered service providers.

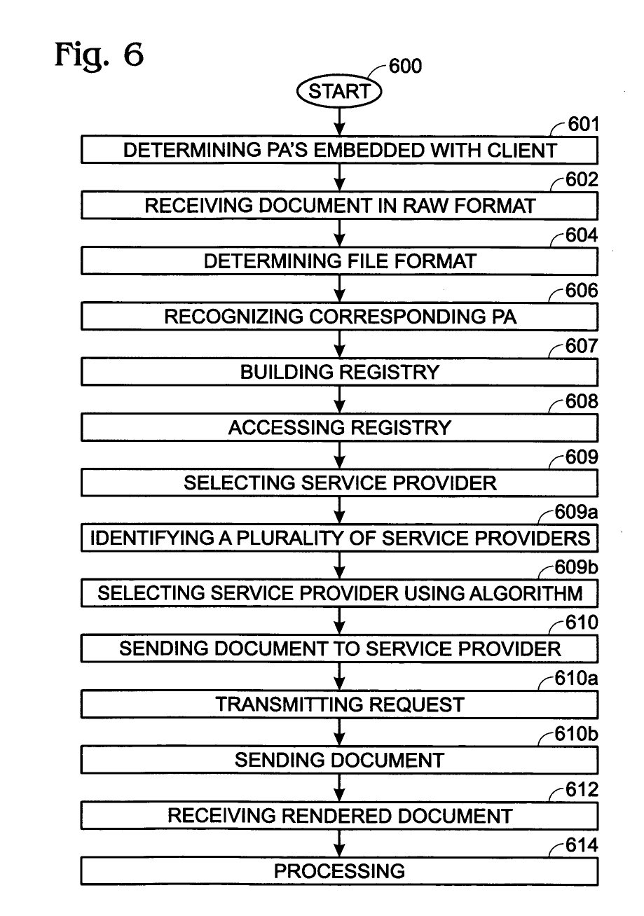

FIG. 5 is another depiction of an exemplary service provider registry. At registration time, each service provider sends a list of extensions that it supports. MFP looks at the list of service providers, to discover which service provider supports a given extension. If one is not found, then a denial is sent back to user terminal, and the print operation fails. If a service provider is found, then the raw file is sent to that service provider.

The service provider receives a raw file (e.g., filename.ext) from the MFP. The service provider can open the file because it has the associated print application installed. The print application is launched to render the document and the rendered document is sent back to the MFP.

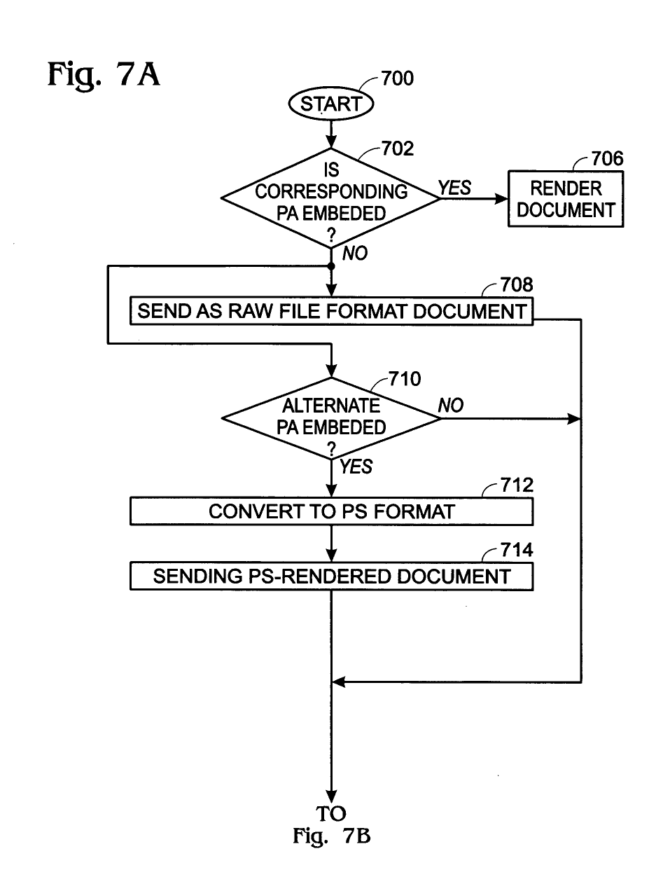

FIG. 6 is a flowchart illustrating a method for processing digital documents using a print application manager. Although the method is depicted as a sequence of numbered steps for clarity, no order should be inferred from the numbering unless explicitly stated. It should be understood that some of these steps may be skipped, performed in parallel, or performed without the requirement of maintaining a strict order of sequence. The method starts at Step 600.

Step 602, at a multifunctional peripheral (MFP), receives a digital document in a raw file format from a network client. Step 604 determines the file format. Step 606 recognizes a print application (PA) corresponding to the determined file format. Step 608 accesses a registry of network-connected service providers cross-referenced to print applications. Step 610 sends the digital document to a service provider with the recognized print application. Step 612 receives a print application-rendered digital document from the service provider. Step 614 processes the rendered digital document at the MFP.

For example, receiving the digital document in the raw file format in Step 602 may include receiving the digital document in a format (file extension) such as .doc, .txt, .pdf, .jpg, .smp, .xls, .html, or .mpp. Receiving the print application-rendered digital document from the service provider in Step 612 includes receiving the rendered digital document in a format such as PCL, PS, or RIP data.

In one aspect, Step 609 selects a service provider from the registry. Then, sending the digital document to a service provider with the recognized print application in Step 610 includes substeps. Step 610a transmits a rendering request to the selected service provider. Step 610b sends the digital document in response to receiving a rendering acknowledgement. In a different aspect, transmitting a rendering request to the selected service provider (Step 610a) includes transmitting a message from a printer browser to a web server embedded in the service provider.

Generally, Step 607 is concerned with building the registry. The various substeps of Step 607 are described but not specifically shown in the figure. In one variation, Step 607a discovers connected service providers. Step 607b discovers the print applications embedded with each service provider. Step 607c builds the registry using the service provider print application discoveries. Alternately, Step 607d receives detection queries from service providers (network clients). Step 607e receives registry messages from the service providers including available embedded print applications. Step 607f builds the registry using the registry messages. Note, the above-mentioned steps are not necessarily performed immediately prior to accessing the registry in Step 608. In fact, the registry may be built prior to receiving the documents in raw file format (Step 602).

In some aspects, Step 602 receives the digital document in a raw file format associated with a first operating system (OS). Then, accessing the registry of network-connected service providers (Step 608) includes accessing a registry where service providers are cross-referenced to print applications, differentiated by OS. Likewise, Step 612 receives a first OS differentiated print application-rendered digital document from the service provider.

In another aspect, recognizing a print application corresponding to the determined file format (Step 606) includes recognizing a first print application. Then, selecting a service provider from the registry in Step 609 includes substeps. Step 609a identifies a plurality of service providers cross-referenced to the first print application. Step 609b selects the service provider using an algorithm such as random or round-robin. Other selection mechanisms were mentioned above.

In a different aspect, Step 601 determines print applications embedded with the network client. As noted above, this is a process conducted by the network client pre-selector application. Then, building a registry in Step 607 includes adding the network client to the registry as a service provider.

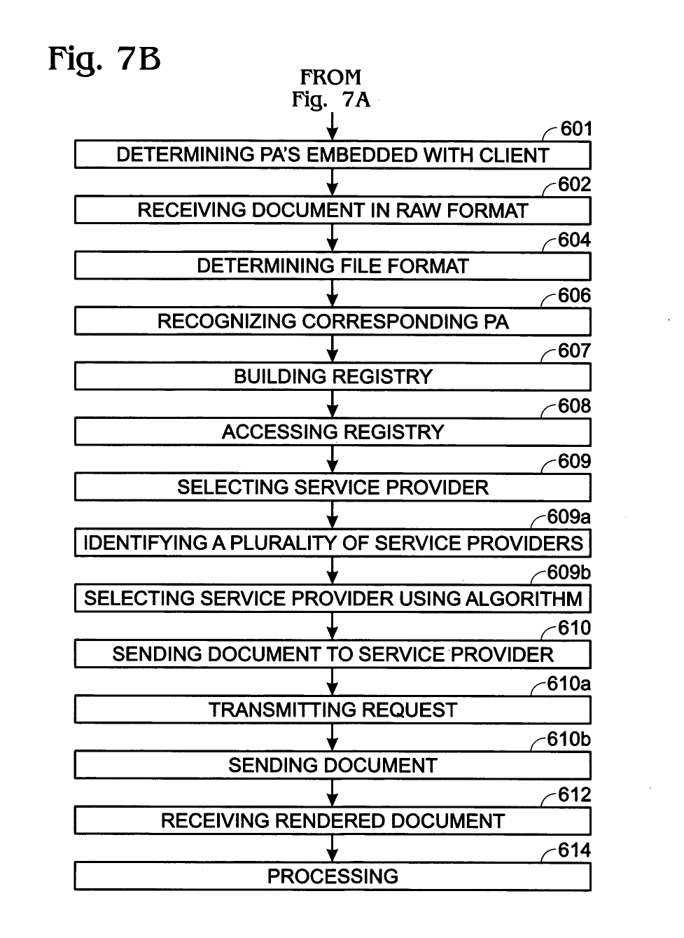

FIGS. 7A and 7B are flowcharts illustrating a variation in the method for processing digital documents using a print application manager. FIGS. 7A and 7B illustrate processes that may be conducted at the network client, prior to sending a document to the MFP. Steps 602 through Steps 614 are the same as described in the explanation of FIG. 6, and their explanation is not repeated in the interest of brevity. The method starts at Step 700.

Step 702, prior to receiving the digital document in a raw file format at the MFP (Step 602), determines if a print application is embedded in the network client that corresponds to the file format. If a corresponding print application is embedded, Step 706 renders the digital document and sends the print application-rendered digital document to the MFP for processing. If the corresponding print application is not embedded, Step 708 sends the digital document to the MFP in raw file format.

As an alternative to Step 708 (if the corresponding print application is not embedded), Step 710 determines if an alternate print application is embedded in the network client. If so, Step 712 converts the digital document from the raw format to PS format, and Step 714 sends the PS-rendered digital document to the MFP for additional rendering. In this aspect, the PS-rendered document can be considered to be a document in raw or semi-raw format. As this point, the method continues to Step 602 and beyond, as described above.

A system and method for processing digital documents using a network print application manager. The invention has been described in the context of MFP and network printers. However, the invention has application to a broader class of network-connected devices. Likewise, the invention has been described using specific applications, document processes, and file extensions. Again, it should be understood that the invention is not limited to merely the example applications, processes, and formats. Other variations and embodiments of the invention will occur to those skilled in the art.

We claim:

1. A method for processing digital documents using a print application manager, the method comprising:
at a multifunctional peripheral (MFP), receiving a digital document in a raw file format from a network client;
determining the file format;
recognizing a print application corresponding to the determined file format;
accessing a registry of network-connected service providers cross-referenced to print applications;
sending the digital document to a service provider with the recognized print application; and
receiving a print application-rendered digital document from the service provider.

2. The method of claim 1 further comprising:
processing the rendered digital document at the MFP.

3. The method of claim 1 wherein receiving the digital document in the raw file format includes receiving the digital document in a format selected from the group including .doc, .txt, .pdf, .jpg, .smp, .xls, .html, and .mpp; and
wherein receiving the print application-rendered digital document from the service provider includes receiving the rendered digital document in a format selected from the group including printer control language (PCL), PostScript (PS), and raster image processing (RIP) data.

4. The method of claim 1 further comprising:
selecting a service provider from the registry;
wherein sending the digital document to a service provider with the recognized print application includes:
transmitting a rendering request to the selected service provider; and
sending the digital document in response to receiving a rendering acknowledgement.

5. The method of claim 1 further comprising:
discovering connected service providers;
discovering the print applications embedded with each service provider; and
building the registry using the service provider print application discoveries.

6. The method of claim 1 further comprising:
receiving detection queries from service providers;
receiving registry messages from the service providers including available embedded print applications; and
building the registry using the registry messages.

7. The method of claim 4 wherein receiving the digital document in the raw file format from the network client includes receiving the digital document in a raw file format associated with a first operating system (OS);
wherein accessing the registry of network-connected service providers includes accessing a registry where service providers are cross-referenced to print applications, differentiated by OS; and
wherein receiving the print application-rendered digital document includes receiving a first OS differentiated print application-rendered digital document from the service provider.

8. The method of claim 4 wherein transmitting a rendering request to the selected service provider includes transmitting a message from a printer browser to a web server embedded in the service provider.

9. The method of claim 4 wherein recognizing a print application corresponding to the determined file format includes recognizing a first print application;
wherein selecting a service provider from the registry includes:
identifying a plurality of service providers cross-referenced to the first print application; and,
selecting the service provider using an algorithm selected from the group including random and round-robin.

10. The method of claim 1 further comprising:
prior to receiving the digital document in a raw file format at the MFP, determining if a print application is embedded in the network client that corresponds to the file format;
if a corresponding print application is embedded, rendering the digital document and sending the print application-rendered digital document to the MFP for processing; and
if the corresponding print application is not embedded, sending the digital document to the MFP in raw file format.

11. The method of claim 10 further comprising:
if the corresponding print application is not embedded, determining if an alternate print application is embedded in the network client;
converting the digital document from the raw format to PS format; and
sending the PS-rendered digital document to the MFP for additional rendering.

12. The method of claim 1 further comprising:
determining print applications embedded with the network client; and
adding the network client to the registry as a service provider.

13. A digital document processing system for centrally managing digital document processing print applications, the system comprising:
a registry of network-connected service providers cross-referenced to print applications;
a format analyzer having an interface to accept a digital document in a raw file format, the format analyzer determining the file format and recognizing a print application corresponding to the determined file format; and
a driver manager having an interface for sending the digital document in the raw file format to a service provider with the recognized print application, and to receive a print application-rendered digital document from the service provider.

14. The system of claim 13 further comprising:
a document processor having an interface to accept the rendered digital document and to provide a processed document.

15. The system of claim 13 wherein the format analyzer receives the digital document in a raw file format selected from the group including .doc, .txt, .pdf, .jpg, .smp, .xls, .html, and .mpp; and
wherein driver manager receives a print application-rendered digital document in a format selected from the group including printer control language (PCL), PostScript (PS), and raster image processing (RIP) data.

16. The system of claim 13 wherein the driver manager selects a service provider from the registry, transmits a rendering request to the selected service provider, and sends the digital document in response to receiving a rendering acknowledgement.

17. The system of claim 13 further comprising:
a network scanner having an interface to discover connected service providers, to discover the print applications embedded with each service provider, and to build the registry using the discoveries.

18. The system of claim 13 wherein the registry receives detection queries from service providers, receives registry messages from the service providers listing available embedded print applications, and builds the registry using the registry messages.

19. The system of claim 16 wherein the format analyzer receives the digital document in a raw file format associated with a first operating system (OS);
wherein the registry cross-references service providers to print applications, differentiated by OS; and
wherein the driver manager receives a first OS differentiated print application-rendered digital document from the service provider.

20. The system of claim 16 further comprising:
a browser having an interface for transmitting a rendering request to a selected service provider web server, in response to a request from the driver manager.

21. The system of claim 13 wherein the registry cross-references a plurality of service providers to a first print application; and
wherein the driver manager selects a first print application service provider from the registry using an algorithm selected from the group including random and round-robin.

22. The system of claim 13 further comprising:
a network client including:
a pre-selector having an interface for accepting the digital document in the raw file format, the pre-selector determining if a print application is embedded in the network client corresponding the file format, and having an interface connected to the MFP for sending the digital document in raw file format if a corresponding print application is not embedded.

23. The system of claim 22 wherein the network client further includes:
a print application having an interface connected to the MFP for sending a print application-rendered digital document; and
wherein the pre-selector sends the digital document in raw file format to the print application for rendering, if the print application corresponds to the file format.

24. The system of claim 22 wherein the network client further includes:
an alternate print application that does not correspond to the digital document raw file format, with an interface connected to the MFP;
wherein the pre-selector determines that the alternate print application is embedded in the network client and, if a corresponding print application is not embedded, sends the digital document to the alternate print application; and
wherein the alternate print application converts the digital document from the raw file format to PS format, and sends PS-rendered digital document to the MFP for additional rendering.

25. The system of claim 22 wherein the network client pre-selector interacts with the MFP registry, registering the network client as a service provider cross-referenced to print application embedded with the network client.

26. A system for centrally managing digital document processing print applications in a network of devices, the system comprising:
a network client having an interface for sending a digital document in a raw file format;
a multifunctional peripheral (MFP) including:
a registry of network-connected service providers cross-referenced to print applications;
a format analyzer having an interface to accept the digital document in the raw file format, the format analyzer determining the file format and recognizing a print application corresponding to the determined file format;
a driver manager having an interface for sending the digital document in the raw file format to a service provider with the recognized print application, and to receive a print application-rendered digital document; and
a service provider including at least one embedded print application having an interface to accept the digital document in raw file format and to supply a print application-rendered digital document to the printer driver manager.

27. The system of claim 26 wherein the network client is a device selected from the group including a personal computer (PC), cellular telephone, and personal digital assistant (PDA).

28. The system of claim 26 wherein the service provider is a device selected from the group including PC and network server.

29. The system of claim 26 wherein the network client further includes a pre-selector having an interface for accepting a digital document in a raw file format, the pre-selector determining if a print application is embedded in the network client corresponding the file format, and having an interface connected to the MFP for sending the digital document in raw file format if a corresponding print application is not embedded.

30. The system of claim 29 wherein the network client further includes a print application having an interface connected to the MFP for sending a first print application-rendered digital document; and
wherein the network client pre-selector sends the digital document in raw file format to the print application for rendering, if the first print application corresponds to the file format.

31. The system of claim 30 wherein the network client is registered in the MFP registry as a service provider cross-referenced to the first print application.
